(19) United States
(12) Patent Application Publication
(10) Pub. No.: US 2003/0172248 A1
(43) Pub. Date: Sep. 11, 2003

(54) Synergetic computing system

(76) Inventor: Nikolai Victorovich Streltsov, Ekaterinburg (RU)

Correspondence Address: LARSON & TAYLOR, PLC, 1199 NORTH FAIRFAX STREET, SUITE 900, ALEXANDRIA, VA, 22314, US

(21) Appl. No.: 10/296,461

(22) PCT Filed: Jun. 8, 2001
(86) PCT No.: PCT/DK01/00393

(30) Foreign Application Priority Data
Jun. 13, 2000 (RU) 2000114808
Oct. 25, 2000 (RU) 2000126657

(51) Int. Cl. G06F 9/30

(52) U.S. Cl. 712/21; 712/15

(57) ABSTRACT

Synergetic computing system contains a unidirectional each-to-each switchboard (2) with N inputs and 2*N outputs, with N functional units (1.1, . . . , 1.N) attached, each unit executing its own program (a sequence of binary and unary operations). Results of operations are sent to the switchboard and used as operands by other functional units. The final result of computation is formed as a result of programmed coordinated interaction (synergy) of the functional units (1.1, . . . , 1.N). Two operating modes are suggested, synchronous and asynchronous. The synchronous mode uses a two-stage pipeline and duration of individual operations has to be taken into account when writing the code. An instruction using a result of another instruction should begin execution in the cycle immediately following the generation of this result. In the asynchronous mode, programming does not need to account for instruction duration and operations are performed upon operand availability. Asynchronous execution is achieved by introducing dynamically assigned individual identification tags for instructions, operands and operation results, and by using ready flags for results, operands and instructions, with buffering of information exchange between concurrent processes in the system.

### FIELD OF INVENTION

The invention is related to computing—namely, to the architecture of high-performance parallel computing systems.

### PRIOR ART

A device is known under the name of IA-64 microprocessor (I.Shakhnovich, Elektronika: Nauka, Tekhnologiya, Biznes, 1999, No. 6, p. 8-11) implementing parallel computing at the instruction level using the very long instruction word (VLIW) concept. The device consists of 1^{st} level instruction cache, 1^{st} level data cache, 2^{nd} and 3^{rd} level common cache, a control device, a specialized register file (integer, floating-point, branching and predicate registers), and a group of functional units of four types: four integer arithmetic units, two floating-point arithmetic units, three branching units, and one data memory access units. Functional units operate under centralized control using fixed-size long instruction words, each containing three simple instructions specifying operations for three different functional units. The sequence of execution of the simple operations within a word and interdependency between words is specified by a mask field in the word.

This device has the following disadvantages:

additional memory expense for the program code caused by the fixed instruction word length;

sub-optimal use of functional units and hence, a decrease in performance because of imbalance between the number of functional units and the number of simple instructions in the instruction word, specialization of functional units and registers, and insufficient throughput of the memory access unit (max. one number per cycle) to match the capacities of the integer and floating-point arithmetic units.

Another known device, an E2K microprocessor (M. Kuzminsky, Russian microprocessors: Elbrus 2K, Otkrytye sistemy, 1999, No. 5-6, p. 8-13) uses the same VLIW concept to implement parallel architecture. The device consists of 1^{st} level instruction cache, 1^{st} level data cache, 2^{nd} level common cache, a prefetch buffer, a control unit, a general-purpose register file, and a group of identical ALU-based functional units grouped in two clusters. Instruction words controlling the operation of functional units have variable length.

A disadvantage of this device is a decrease in throughput on reloading of 1^{st} level instruction cache (because of a mismatch between instruction fetch rate and cache fill rate) or under intense use of data from the 2^{nd} level common cache or the main memory.

Other known devices, also implemented using the VLIW concept, are digital signal processors (DSPs) of the TMS320C6x family with the VelociTI architecture (V. Korneyev, A. Kiselyov, Modern microprocessors, Moscow, 2000, p. 217-220) and ManArray architecture DSPs (U.S. Pat. No. 6,023,753; U.S. Pat. No. 6,101,592).

Disadvantages of the above devices are:

sub-optimal use of the program memory resources;

mismatch between the main data memory access rate and the capacities of the operating units (ALUs, multipliers, etc.) leading to a decrease in performance.

A common disadvantage of all above devices is the implementation of concurrent processing only at the lowest level, that of a single linear span of the program code. The VLIW concept does not allow unrelated code spans or separate programs to be executed concurrently.

A higher level of multisequencing is provided by another known device, Kin multiscalar microprocessor (V. Korneyev, A. Kiselyov, Modern microprocessors, Moscow, 2000, p. 75-76) implementing concurrency at the level of basic blocks. A basic block is a sequence of instructions processing data in registers and memory and ending with a branch instruction, i.e., a linear span of code. The microprocessor consists of different functional units: branch instruction interpreters, arithmetic, logical and shift instruction interpreters, and memory access units. Data exchange between functional units is asynchronous and occurs via FIFO queues. Every unit fetches elements from its input queue as they arrive, performs an operation and places the result into the output queue. In this organization, the instruction flow is distributed between units as a sequence of packets containing tags and other necessary information to control the functional units.

Instruction fetching and decoding is centralized, and decoded instructions for a given basic block are placed into the decoded instruction cache. Upon such placement, every instruction is assigned a unique dynamic tag. After the register renaming units eliminate extraneous WAR and WAW dependencies between instructions, they are sent to the out-of-line execution controller.

From the out-of-line execution controller, instructions are sent to the reservation stations and wait for their operands to become available to begin execution.

Instructions with ready operands are sent by the reservation stations to the functional units for the execution, and the results are sent back to the reservation stations, out-of-line execution controller and, in case of a branch, to the instruction prefetch unit.

Disadvantages of this device are:

complicated logic of out-of-line execution and hardware check for instruction interdependency, which increases unproductive delays and the volume of hardware to support dynamic multisequencing;

efficient multisequencing is practically limited to the level of linear code spans (basic blocks), because multisequencing within a basic block is performed dynamically at runtime and does not have sufficient time to analyze and optimize information links between instructions;

lack of concurrent execution possibility for several different programs;

significant unproductive losses caused by avid instruction prefetch in case of a mispredicted branch.

The device closest to the claim in its technical substance and the accomplishments is the QA-2 computer (prototype described in: T. Motoöka, S. Tomita, H. Tanaka et al., VLSI-based computers; Russian version: Moscow, 1988, pp. 65-66, 155-158). This device consists of a control unit, a shared array of specialized registers, a switching network, N identical universal ALU-based functional units (for the prototype implementation described N=4). The switching network operates on each-to-each principle, has N inputs and 2N outputs and can directly connect the output of any ALU to the inputs of other ALUs.

The device operates under centralized control. A fixed-length long instruction word contains four fields (simple instructions) to control ALUs, a field to access four different banks of main memory, and a field to control the sequence of execution of simple instructions. Simple instructions contain operation code, operand lengths, operand source register addresses, destination register address.

The disadvantages of this device are as follows. Fixed instruction word length leads to sub-optimal use of memory resources, as a field is present in the instruction regardless of whether the corresponding ALU is used or not. Other performance-decreasing factors are the lack of direct ALU access to data in memory, as the data should first be placed in the shared register array, and the use of operations with different duration in the same instruction word. In the latter case, short operations have to wait for the longest one to complete. This device does not implement multisequencing at the code span or program level, either.

### DISCLOSURE OF THE INVENTION

The invention is related to the problem of increasing the performance of a computing system by reducing the idle time of the operational devices and by multisequencing at the instruction level and/or at the linear code span and program level, in any combination.

The problem is resolved by a synergetic computing system according to claim 1 containing N functional units, an each-to-each switchboard with N data inputs, 2N address inputs and 2N data outputs. According to the invention, every functional unit contains a control device, program memory and operational device implementing unary and binary operations, and has two data inputs, two address outputs and one data output. First data input of the k-th functional unit (k=1, . . . , N) is connected to the (2k−1)-th data output of the switchboard, second data input—to the 2k-th data output of the switchboard, first address output—to the (2k−1)-th address input of the switchboard, second address output—to the 2k-th address input of the switchboard, and data output—to the k-th data input of the switchboard. Data input of the functional unit are data inputs of the control device, address outputs of the functional units are respectively first and second address outputs of the control device, whereas the third address output of the control device is connected to the address input of the program memory, instruction input/output of the control device is connected to the instruction input/output of the program memory, control output of the control device is connected to the control input of the operational device, first and second data outputs of the control device are respectively connected to the first and second data inputs of the operational device, data output of the operational device is the data output of the functional unit. Operational device contains an input/output (I/O) device and/or an arithmetic and logic unit (ALU) and/or data memory, where first data input of the operational device is the data input of the I/O device, ALU and data memory, second data input of the operational device is the address input of the I/O device and data memory and the second data input of the ALU, control input of the operational device is the control input of the I/O device, ALU and data memory, and data output of the I/O device, ALU or data memory is the data output of the operational device.

For the second variant of the present invention, as defined by claim 2, an asynchronous synergetic computing system, functional unit shall also have two operand tag inputs, two operand availability flag inputs, operand tag output, two operand request flag outputs, result tag output, result flag output, logical number output, N instruction fetch permission flag inputs and an instruction fetch permission flag output. The switchboard in this case shall have N result tag inputs, N result availability flag inputs, N operand tag inputs, 2N operand request flag inputs, N logical number inputs, 2N operand tag outputs, 2N operand availability flag outputs. Inputs and outputs are interconnected as follows: first and second operand tag inputs of the k-th functional unit (k=1, . . . , N) are respectively connected to the (2k−1)-th and 2k-th operand tag outputs of the switchboard. First and second operand availability flag inputs are respectively connected to (2k−1)-th and 2k-th operand availability flag outputs of the switchboard, Operand tag output of the k-th functional unit is connected to the k-th operand tag input of the switchboard. First and second operand request flag outputs are respectively connected to the (2k−1)-th and the 2k-th operand request flag inputs of the switchboard. Result tag output of the k-th functional unit is connected to the k-th result tag input of the switchboard, result availability flag output is connected to the k-th result availability flag input of the switchboard. Instruction fetch permission flag output is connected to the k-th instruction fetch permission flag input of all functional units. Operand tag inputs and operand availability flag inputs of the functional unit are respective inputs of the control device. Operand tag output and operand request flag outputs of the functional unit are respective outputs of the control device. Tag output of the control device is connected to the tag input of the operational device. Result tag output and result availability flag output of the operational device are respective outputs of the functional unit. Logical number output, N instruction fetch permission flag inputs, and instruction fetch permission flag output of the functional unit are respective outputs (inputs) of the control device. Control device consists of instruction fetcher, instruction decoder, instruction assembler, instruction execution controller, instruction fetch gate, N-bit data interconnect register, busy tag memory, operand availability memory, operation code buffer, first operand buffer, second operand buffer, the latter five memory units consisting of L cells each. The address output of the instruction fetcher is the third address output of the control device, instruction output of the instruction fetcher of the instruction output of the control device, first tag output of the instruction fetcher is connected to the read address input of the busy tag memory. Tag busy flag input of the instruction fetcher is connected to the data output of the busy tag memory, second tag output of the instruction fetcher is connected to the tag input of the instruction decoder and to the write address input of the busy tag memory, and the tag busy flag output of the instruction fetcher is connected to the data input of the busy tag memory. Control input of the instruction fetcher is connected to control output of the instruction decoder, data input of the instruction fetcher is connected to the third data output of the instruction execution controller, and instruction fetch permission flag output of the instruction fetcher is the corresponding output of the control device. Instruction input of the instruction decoder is the instruction input of the control device, and its operant tag outputs, operand request flag outputs, and address outputs are respective outputs of the control device. Data/control output of the instruction decoder is connected to the data/control input of the instruction assembler; its operand tag inputs, operand availability flag inputs and data inputs are corresponding inputs of the control device. First tag output of the instruction assembler is connected to the address input of the operand availability memory; second, third and fourth tag outputs of the instruction assembler are respectively connected to the write address inputs of the opcode buffer, first operand buffer and second operand buffer. First data input/output of the instruction assembler is connected to the data input/output of the operand availability memory; second, third and fourth data outputs of the instruction assembler are respectively connected to the data inputs of the opcode buffer, first operand buffer and second operand buffer. Instruction ready flag output of the instruction assembler is connected to the instruction ready flag input of the instruction execution controller. Fifth tag output of the instruction assembler is connected to the tag input of the instruction execution controller; its first, second and third tag outputs are respectively connected to the read address inputs of the opcode buffer, first operand buffer and second operand buffer, and its first, second and third data inputs are respectively connected to the data outputs of the opcode buffer, first operand buffer and second operand buffer. Logical number output of the instruction execution controller is the corresponding output of the control device. Fourth tag output of the instruction execution controller is connected to the write address input of the busy tag memory, and tag busy flag output of the instruction execution controller is connected to the data input of the busy tag memory. Data interconnect output of the instruction execution controller is connected to the input of the data interconnect register. Fifth tag output of the instruction execution controller is the tag output of the control device; control output, first and second data outputs of the instruction execution controller are the respective outputs of the control device. Output of the data interconnect register is connected to the data interconnect input of the instruction fetch gate; its fetch permission flag output is connected to the corresponding input of the instruction fetcher. N instruction fetch permission flag inputs of the instruction fetch gate are the corresponding inputs of the control device. Tag input of the operational device is the tag input of the I/O device, the ALU and the data memory. Result tag output and result availability flag output of the I/O device, the ALU and the data memory are respectively the result tag output and the result availability flag output of the operational device. The switchboard consists of N switching nodes, each of them comprising N selectors, each containing a ]log₂N[-bit logical number register, request flag generator, L-word request flag memory, and two FIFO buffers. In all switching nodes, for the k-th selector (k=1, . . . , N), k-th data input of the switchboard is connected to the first data inputs of the FIFO buffers, k-th result tag input is connected to the second data inputs of the FIFO buffers and to the read address input of the request flag memory, k-th result availability flag input is connected to the read gate input of the request flag memory. In all selectors of the k-th switching node (k=1, . . . , N), (2k−1)-th address input of the switchboard is connected to the first operand address inputs of the request flag generators, 2k-th address input of the switchboard is connected to the second operand address inputs of the request flag generators, (2k−1)-th operand request flag input is connected to the first operand request flag inputs of the request flag generators, 2k-th operand request flag input is connected to the second operand request flag inputs of the request flag generators, k-th logical number input is connected to the inputs of the logical number registers, k-th operand tag input is connected to the write address inputs of the request flag memories. For all selectors, logical number register output is connected to the logical number input of the request flag generator, operand present flag output of the request flag generator is connected to the write gate input of the request flag memory, first and second operand request flag outputs are respectively connected to the first and second data inputs of the request flag memory. First data output of the request flag memory is connected to the write gate input of the first FIFO buffer, second data output of the request flag memory is connected to the write gate input of the second FIFO buffer. All first FIFO buffers in the k-th switching node are polled using the read gate in the round-robin discipline, and all first data outputs of the first FIFO buffers are connected together and form the (2k−1)-th data output of the switchboard. All second data outputs of the first FIFO buffers are also connected together and form the (2k−1)-th operand tag output of the switchboard, operand availability flag outputs of the first FIFO buffers are connected together and form the (2k−1)-th operand availability flag output of the switchboard. All second FIFO buffers in the k-th switching node are also polled in the round-robin discipline using the read gate, and first data outputs of the second FIFO buffers are connected together and form the 2k-th data output of the switchboard. Second data outputs of the second FIFO buffers are connected together and form the 2k-th operand tag output of the switchboard, operand availability flag outputs of the second FIFO buffers are connected together and form the 2k-th operand availability flag output of the switchboard.

Design features of the present device are essential and in their combination lead to an increase in system performance. The reason for this is that the functional units implementing input/output and data read/write operations are connected to the each-to-each switchboard in the same manner as other units of the synergetic system, thereby allowing to exclude the intermediate data storage (a register array) and accordingly shorten the data access time; by selecting the proportion between the types of functional units, it is possible to bring the flow of data up to the full processing capacity of the system, limited only by the features of the given algorithm and the limitation on the number of functional units in the system. Decentralized control of the instruction flow in the synergetic computing system implemented by the abovementioned arrangement of the control device and program memory in each functional unit, together with decentralized control of the switchboard via address inputs connected to the address outputs of the control devices, allow to eliminate delays in the computation process caused by cache refilling, as the length of an instruction word becomes substantially smaller. Thus, for a 16-unit system, most instructions are 16 bits long, which is several times shorter than in the prior systems, and there is no need for an instruction cache. The necessary instruction fetch rate may by simply provided by parallel access (simultaneous fetching of several consecutive instruction words). Decentralized control also allows to implement concurrency at any level by appropriate distribution of functional units among instructions, linear code spans, or programs while writing the code.

In the asynchronous synergetic computing system, the use of tags for instructions, operands and results, buffering of data exchange between concurrent processes in the system, and the use of “ready” flags for results, operands and instructions provide for asynchronous execution of instructions with transfer of results immediately upon completion of an operation and execution of instructions upon availability of operands. Data-driven execution of instructions (upon availability of operands) allows to disregard individual instruction delay times in compile-time multisequencing, and reduces the idle time of the functional units compared to the pipelined architecture.

It should be further noted that the standardization of the intra-system links between units together with the possibility of using different types of functional units in the system, with different operational capabilities, allow to optimize the amount of hardware and its power consumption in specialized applications. Data interconnect register, a feature of the architecture, allows to organize concurrent independent execution of tasks unrelated by data. Logical number registers allow to provide standby units and efficiently reconfigure the system in case of failure of an individual functional unit.

### DESCRIPTION OF DRAWINGS

The present invention is explicated by the following figures:

FIG. 1 presents the structure of the synergetic computing system;

FIG. 2 presents main formats of instruction words;

FIG. 3 graphically represents formula F.1 in a multi-layer form;

FIG. 4 graphically represents formula F.2 in a multi-layer form;

FIG. 5 presents the structure of the k-th functional unit of the asynchronous synergetic computing system;

FIG. 6 presents the structure of the switchboard of the asynchronous synergetic computing system;

FIG. 7 presents the structure of the k-th switching node.

### BEST EMBODIMENT OF THE INVENTION

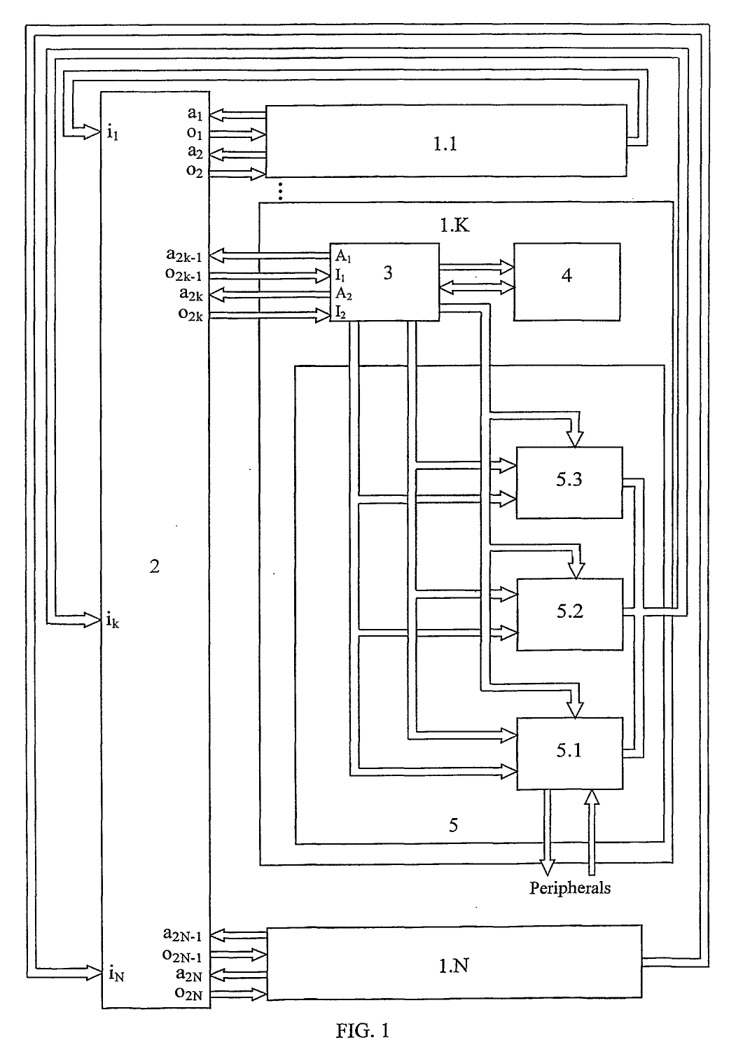

The synergetic computing system (FIG. 1) contains functional units 1.1 , . . . , 1.K, . . . ,1.N, each-to-each switchboard 2 with N data inputs i₁, . . . ,iₖ, . . . ,i_{N}, 2N address inputs a₁, a₂, . . . , a₂ₖ₋₁, a₂ₖ, . . . , a_{2N-1}, a_{2N}, 2N data outputs O₁, O₂, . . . , O₂ₖ₋₁, O₂ₖ, . . . , O_{2N-1}, O_{2N}. Every functional unit consists of the control device 3, program memory 4 and the operational device 5 implementing binary and unary operations, which has two data inputs I₁ and I₂, two address outputs A₁ and A₂ and a data output O. Data input I₁ of the k-th functional unit (k=1, . . . , N) is connected to the data output O₂ₖ₋₁ of the switchboard, data input I₂ is connected to the data output O₂ₖ of the switchboard. Address output A₁ is connected to the address input a₂ₖ₋₁ of the switchboard, address output A₂ is connected to the address input a₂ₖ of the switchboard, data output O of the k-th functional unit is connected to the data input iₖ of the switchboard. Data inputs of the functional unit are the data inputs of the control device 3, address outputs of the functional unit are, respectively, first and second address outputs of the control device 3, third address output of the control device 3 is connected to the address input of the program memory 4, instruction input/output of the control device 3 is connected to the instruction input/output of the program memory 4, control output of the control device 3 is connected to the control input of the operational device 5, first and second data outputs of the control device are respectively connected to the first and second data inputs of the operational device 5, data output of the operational device 5 is the data output of the functional unit. Operational device 5 contains an I/O device 5.1 and/or ALU 5.2 and/or data memory 5.3, where first data input of the operational device 5 is the data input of the I/O device 5.1, ALU 5.2 and data memory 5.3; second data input of the operational device 5 is the address input of the I/O device 5.1 and data memory 5.3, and the second data input of the ALU 5.2; control input of the operational device 5 is the control input of the I/O device 5.1, ALU 5.2 and data memory 5.3; data output of the I/O device 5.1, ALU 5.2 and data memory 5.3 is the data output of the operational device 5.

The synergetic computing system operates as follows.

The initial state of the program memory and the data memory is entered through the units implementing I/O operations in the form of instruction word and data word sequences, respectively. The input (bootstrap) code occupies a certain bank in the program memory physically implemented as a separate nonvolatile memory device (chip).

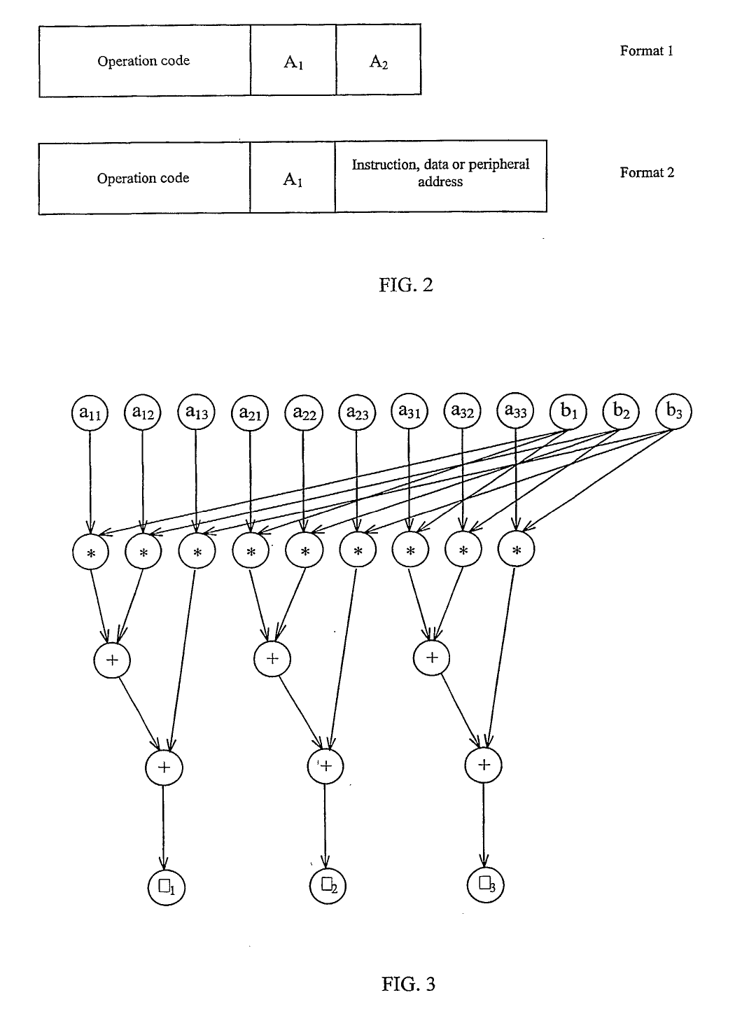

Instruction words (FIG. 2) have two formats. First format contains an opcode field and two operand address fields. Second format consists of an opcode field, an operand address fields, and a field with an address of an instruction, data or a peripheral. The opcode field size is determined by the instruction set and should be at least ]log₂ P[ bits, where P is the number of instructions in the set. Operand address field sizes are determined by the number of units in the system; they should be at least ]log₂ N[ bits long each. Size and structure of the field with an address of an instruction, data or peripheral is determined by the maximum addressable program memory, data memory and number of peripherals, as well as by the effective address calculation method.

Data word length is determined by system implementation—namely, by the type, form and precision of data representation.

All functional units of the synergetic computing system (FIG. 1) operate simultaneously, concurrently and independently according to the program code in their program memories. Every instruction implements a binary or unary operation and is executed in two-stage pipelined mode for a given integer number of clock cycles; upon completion, the result is sent to the switchboard 2. At the first stage of instruction execution, control device 3 of the functional unit fetches an instruction word from the program memory 4, unpacks it, generates the appropriate control signals for the operational device 5 according to the operation code, takes operand addresses A₁ and A₂ from the appropriate fields and sends them to the switchboard 2 via the address outputs. At the second stage, switchboard 2 directly connects first and second data inputs of the functional unit to the outputs of the functional units addressed via the first and second operand address inputs, thus transmitting the results of the previous operation from functional unit outputs to other units' inputs. The data are used by the operational device 5 during the second stage as operands for the binary or unary operation, the result of which is sent to the switchboard 2 for the next instruction. An address of an instruction, data or peripheral from a format 2 instruction (FIG. 2) is handled directly by the control device when executing branch instructions, data read/write and input/output instructions, as well as operations with one operand residing in this unit's data memory. Presented below are two examples of the synergetic computing system operation. Two formulae are used as examples:

$$\begin{matrix}( {c}_{1} , {c}_{2} , {c}_{3} ) = ( \begin{matrix}{a}_{11} {a}_{12} {a}_{13} \\ {a}_{21} {a}_{22} {a}_{23} \\ {a}_{31} {a}_{32} {a}_{33}\end{matrix} ) \cdot ( \begin{matrix}{b}_{1} \\ {b}_{2} \\ {b}_{3}\end{matrix} ) & ( F .1 ) \\ w = ( ( e - d ) \cdot x - y ) \cdot ( \frac{e - d}{x + y} \cdot z - x + y - v ) & ( F .2 )\end{matrix}$$

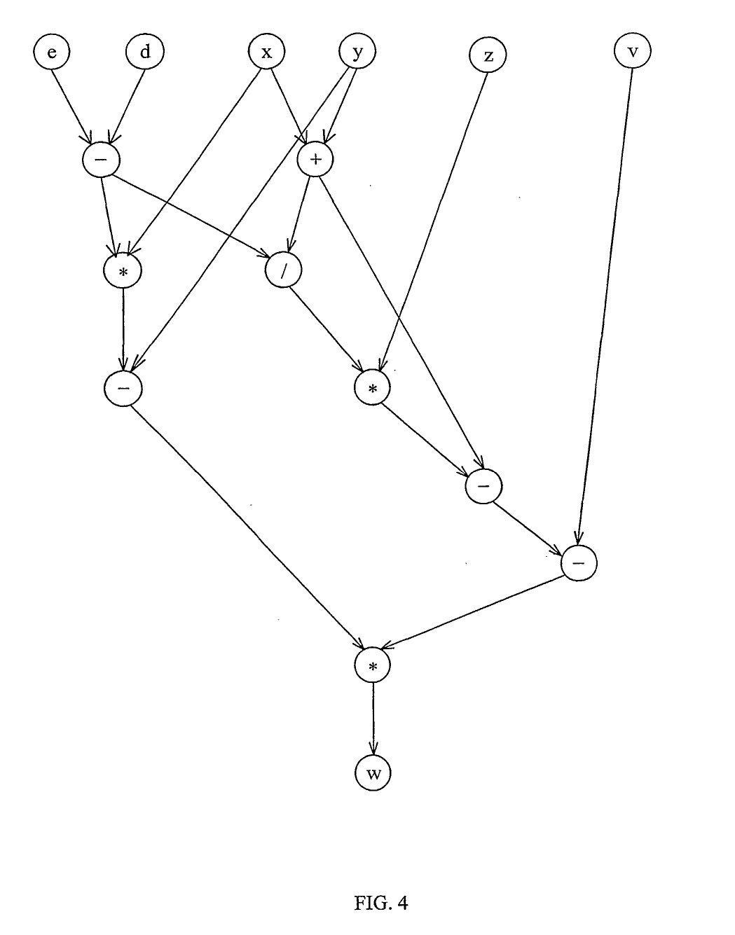

Data graphs describing the sequence of operations in the formulae and their concurrency are presented in multi-layer form in FIG. 3 and 4.

Assume for the given examples that the synergetic computing system consists of 16 functional units, of which units 1 to 7 have only data memory in their operational devices, units 8 to 15 are purely computational (have only an ALU), and unit 16 is an I/O unit.

Memory units implement data read (rd) and write (wr) instructions in format 2 which are one clock cycle long. Read is a unary operation fetching data from memory at the address given in the instruction word. Write is a binary operation with the first operand (data) coming from the switchboard and the second operand (address in data memory) specified in the instruction word.

Computational units implement the following operations: addition (+) and subtraction (−), one cycle long; multiplication (*), 2 cycles long; division (/), 4 cycles long. All computational instructions use format 1 for binary operations; subtrahend and dividend are first operands of the respective instructions.

To assure coordinated interaction of the units, it may be necessary to keep the result at the output of the unit for one or more clock cycles. This is done by a delay instruction (d, format 2) which conserves the result of a previous instruction at the unit's output for t clock cycles. The result may also be delayed by one cycle by writing it into a scratch location. Upon completion of a write operation, the data are not only written to the data memory but also appear at the output as the result of the instruction. In long operations, the result of the previous instruction remains at the functional unit's output until the last clock cycle of the current long operation.

Assume the following notation for the instructions:

Format 1 <opcode> <unit>,<unit>

Format 2 <opcode> <unit>,<label>

or <opcode> <label>

or <opcode> <number of cycles>,

where <opcode> is the operation mnemonics, <unit> is a number between 1 and 16 referencing the functional unit whose result is used as an operand for the instruction, <label> is the label of a memory-resident operand the address of which is to be generated in the address field upon assembly and loading of the code.

Delay instructions use the number of cycles instead of the label.

Matrix elements (a₁₁, a₁₂, a₁₃, a₂₁, a₂₂, a₂₃, a₃₁, a₃₂, a₃₃) are placed columnwise in the memory units 1-3. Vectors (b₁, b₂, b₃) and (c₁, c₂, C₃) are placed element by element in the memory units 4-6. Variables e, z, and v reside in the memory unit 4. Variables d, y, reside in the units 5 and 6 respectively. Variables x, w reside in the unit 7.

Scratch locations r₁ and r₃ are allocated in the unit 7 to store intermediate results. To delay the result by one cycle and free up the functional unit, a fictitious operand r₂ is allocated in the unit 4 (this cell is written but never read).

The code computing the formulae and its execution by the functional units are presented in Table 1.

TABLE 1

| | Functional unit number | | | | | | | | | | | | | | | |
|---|---|---|---|---|---|---|---|---|---|---|---|---|---|---|---|---|
| Cycle | 1 | 2 | 3 | 4 | 5 | 6 | 7 | 8 | 9 | 10 | 11 | 12 | 13 | 14 | 15 | 16 |
| 1 | d | d | d | rd | rd | rd | rd | d | d | d | d | d | d | d | d | |
| | 1 | 1 | 1 | □ | d | y | x | 1 | 1 | 2 | 2 | 3 | 3 | 3 | 2 | |
| 2 | rd | rd | rd | rd | rd | rd | − | + | | | | | | | | |
| | □₁₁ | □₁₂ | □₁₃ | b₁ | b₂ | b₃ | 1 | 4, 5 | 6, 7 | | | | | | | |
| 3 | rd | rd | rd | d | d | d | wr | * | * | * | * | | | | / | |
| | □₂₁ | □₂₂ | □₂₃ | 2 | 5 | 2 | 9,r₁ | 1, 4 | 2, 5 | 3, 6 | 7, 8 | | | | 8, 9 | |
| 4 | rd | rd | rd | | | | d | | | | | * | * | * | | |
| | □₃₁ | □₃₂ | □₃₃ | | | | 3 | | | | | 1, 4 | 2, 5 | 3, 6 | | |
| 5 | | | | wr | | rd | | + | * | * | * | | | | | |
| | | | | 11,r₂ | | y | | 8, 9 | 1, 4 | 2, 5 | 3, 6 | | | | | |
| 6 | | | | rd | | d | | + | | | | + | − | d | | |
| | | | | z | | 3 | | 8, 10 | | | | 12, 13 | 4, 6 | 1 | | |
| 7 | | | | wr | | | wr | | + | | d | + | | | * | |
| | | | | 8,c₁ | | | 13,r₃ | | 9, 10 | | 1 | 12, 14 | | | 15, 4 | |
| 8 | | | | d | wr | | rd | | + | | | | | | | |
| | | | | 1 | 12, c₂ | | r₁ | | 9, 11 | | | | | | | |
| 9 | | | | rd | | wr | d | | | | | | | | − | |
| | | | | v | | 9, c₃ | 1 | | | | | | | | 15, 7 | |
| 10 | | | | | | | rd | | | | | | | | − | |
| | | | | | | | r₃ | | | | | | | | 15, 4 | |
| 11 | | | | | | | d | | | | | | | | * | |
| | | | | | | | 2 | | | | | | | | 7, 15 | |
| 12 | | | | | | | | | | | | | | | | |
| 13 | | | | | | | wr | | | | | | | | | |
| | | | | | | | 15, w | | | | | | | | | |
| 14 | | | | | | | | | | | | | | | | |
| | 4 | 4 | 4 | 8 | 4 | 6 | 10 | 5 | 6 | 3 | 4 | 4 | 3 | 3 | 6 | − |

Number of instructions executed

For each unit, instructions are shown vertically, from the top down, in the order of their execution. The length of the cell occupied by an instruction corresponds to its duration. Clock cycles are sequentially numbered in the left column.

The last row of the table shows the number of instructions executed by each of the functional units.

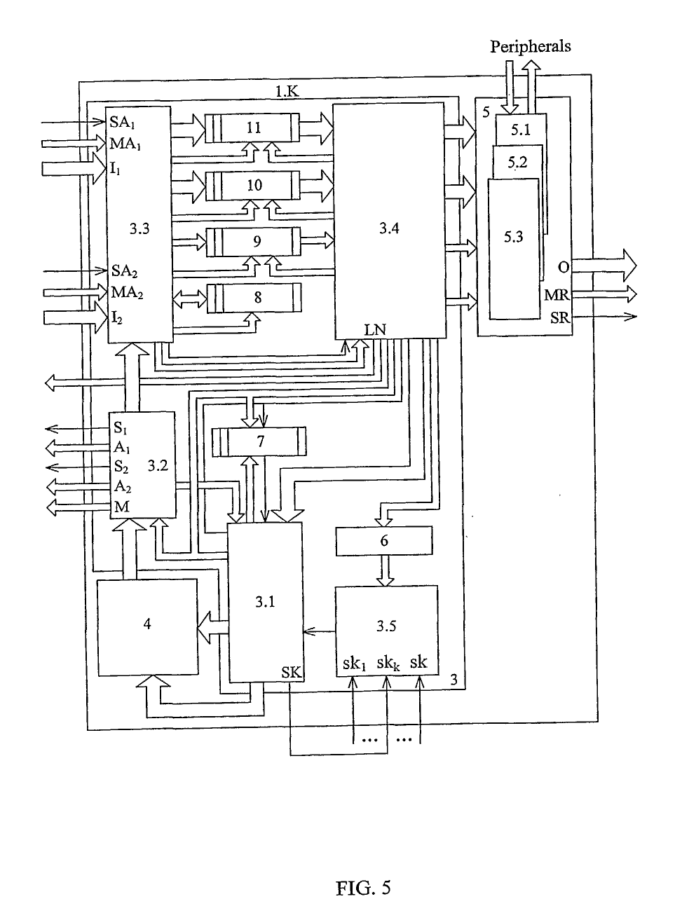

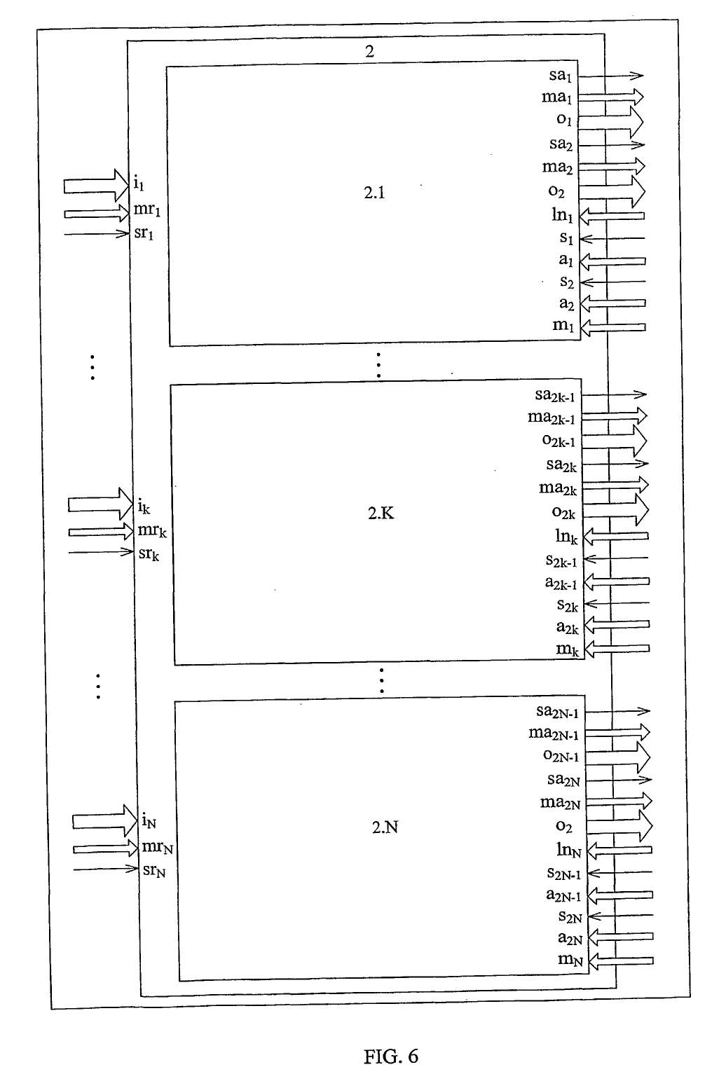

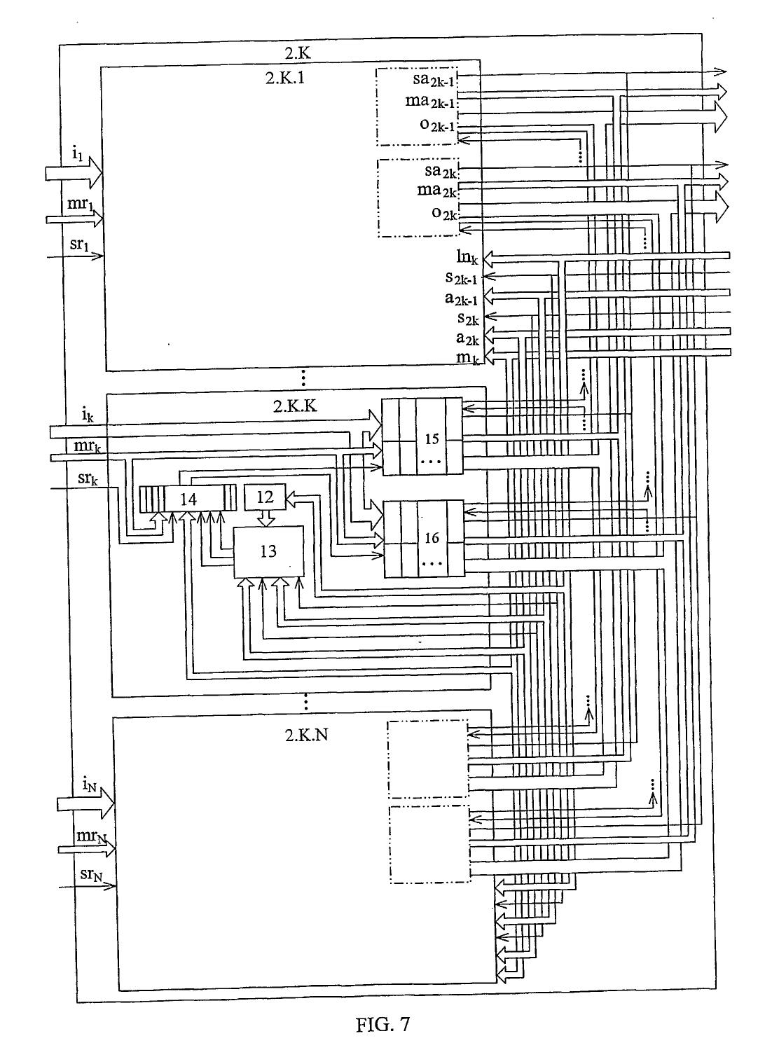

A further development of the synergetic computing system is the asynchronous synergetic computing system (FIGS. 5, 6, 7). Every unit of the system additionally has two operand tag inputs MA₁ and MA₂, two operand availability flag inputs SA₁ and SA₂, operand tag output □, two operand request flag outputs S₁ and S₂, result tag output MR, result availability flag output SR, logical number output LN, N instruction fetch permission flag inputs sk₁, . . . , skₖ, . . . , sk_{N}, instruction fetch permission flag output SK. FIG. 5 illustrates the interconnection and structure of the k-th functional unit. The switchboard (FIG. 6) has N result tag inputs mr₁, . . . , mrₖ, . . . , mr_{N}, N result availability flag inputs sr₁, . . . , srₖ, . . . , sr_{N}, N operand tag inputs m₁, . . . , mₖ, . . . , m_{N}, 2N operand request flag inputs s₁, S₂,. . . , S₂ₖ₋₁, S₂ₖ, . . . , S_{2N-1}, S_{2N}, N logical number inputs ln₁, . . . , lnₖ, . . . , ln_{N}, 2N operand tag outputs ma₁, ma₂, . . . , ma₂ₖ₋₁, ma₂ₖ, . . . , ma_{2N-1}, ma_{2N}, 2N operand availability flag outputs sa₁, sa₂, . . . , sa₂ₖ₋₁, sa₂ₖ, . . . , sa_{2N-1}, sa_{2N}. First and second operand tag inputs MA₁ and MA₂ of the k-th functional unit (k=1, . . . , N) are respectively connected to (2k−1)-th and 2k-th operand tag outputs of the switchboard ma₂ₖ₋₁ and ma₂ₖ, first and second operand availability flag inputs SA₁ and SA₂ are connected, respectively, to (2k−1)-th and 2k-th operand availability flag outputs of the switchboard sa₂ₖ₋₁ and sa₂ₖ. Operand tag output M is connected to the k-th operand tag input of the switchboard mₖ, first and second operand request flag outputs S₁ and S₂ are respectively connected to the (2k−1)-th and 2k-th operand request flag inputs of the switchboard s₂ₖ₋₁ and s₂ₖ. Result tag output MR is connected to the k-th result tag input of the switchboard mrₖ, result availability flag output SR is connected to the k-th result availability flag input of the switchboard srₖ. Instruction fetch permission flag output SK is connected to the k-th instruction fetch permission flag input skₖ, of all functional units. Operand tag inputs MA₁ and MA₂ and operand availability flag inputs SA₁ and SA₂ of the functional unit are corresponding inputs of the control device 3. Operand tag output M, operand request flag outputs S₁ and S₂ of the functional unit are respective outputs of the control device 3. Tag output of the control device 3 is connected to the tag input of the operational device 5. Result tag output MR and result availability flag output SR of the operational device 5 are respective outputs of the functional unit. Logical number output LN, N instruction fetch permission flag inputs sk₁, . . . , skₖ, . . . , sk_{N} and instruction fetch permission flag output SK of the functional unit are respective outputs (inputs) of the control device 3. Control device of the asynchronous synergetic computing system consists of instruction fetcher 3.1, instruction decoder 3.2, instruction assembler 3.3, instruction execution controller 3.4, instruction fetch gate 3.5, data interconnect register 6, busy tag memory 7, operand availability memory 8, opcode buffer 9, first operand buffer 10, and second operand buffer 11. Address output of the instruction fetcher 3.1 is the third address output of the control device 3, instruction output of the instruction fetcher 3.1 is the instruction output of the control device 3. First tag output of the instruction fetcher 3.1 is connected to the read address input of the busy tag memory 7, tag busy flag input of the instruction fetcher 3.1 is connected to the data output of the busy tag memory 7. Second tag output of the instruction fetcher 3.1 is connected to the tag input of the instruction decoder 3.2 and the write address input of the busy tag memory 7; tag busy flag output of the instruction fetcher 3.1 is connected to the data input of the busy tag memory 7. Control input of the instruction fetcher 3.1 is connected to the control output of the instruction decoder 3.2; data input of the instruction fetcher 3.1 is connected to the third data output of the instruction execution controller 3.4; instruction fetch permission flag output SK of the instruction fetcher 3.1 is an output of the control device 3. Instruction input of the instruction decoder 3.2 is the instruction input of the control device 3; operand tag output of the instruction decoder 3.2 is the operand tag output M of the control device 3; first operand request flag output, first address output, second operand request flag output and second address output of the instruction decoder 3.2 are respective outputs S₁, A₁, S₂, □₂ of the control device 3, data/control output of the instruction decoder 3.2 is connected to the data/control input of the instruction assembler 3.3. Operand tag inputs, operand availability flag inputs and data inputs of the instruction assembler 3.3 are respective inputs MA₁, MA₂, SA₁, S□₂, I₁, I₂ of the control device 3. First tag output of the instruction assembler 3.3 is connected to the address input of the operand availability memory 8. Second, third and fourth tag outputs of the instruction assembler 3.3 are respectively connected to the write address inputs opcode buffer 9, first operand buffer 10 and second operand buffer 11. First data input/output of the instruction assembler 3.3 is connected to the data input/output of the operand availability memory 8. Its second, third and fourth data outputs are respectively connected to the data inputs of opcode buffer 9, first operand buffer 10, and second operand buffer 11. Instruction ready flag output of the instruction assembler 3.3 is connected to the instruction ready flag input of the instruction execution controller 3.4. Fifth tag output of the instruction assembler 3.3 is connected to the tag input of the instruction execution controller 3.4; first, second and third tag outputs are respectively connected to the read address inputs of opcode buffer 9, first operand buffer 10, and second operand buffer 11. First, second and third data inputs of the instruction execution controller 3.4 are respectively connected to the data outputs opcode buffer 9, first operand buffer 10 and second operand buffer 11. Logical number output of the instruction execution controller 3.4 is the LN output of the control device. Fourth tag output of the instruction execution controller 3.4 is connected to the write address input of the busy tag memory 7; tag busy flag output of the instruction execution controller 3.4 is connected to the data input of the busy tag memory 7. Data interconnect output of the instruction execution controller 3.4 is connected to the input of the data interconnect register 6. Fifth tag output of the instruction execution controller 3.4 is the tag output of the control device 3. Control output of the instruction execution controller 3.4 is the control output of the control device 3. First and second data outputs of the instruction execution controller 3.4 are, respectively, first and second data outputs of the control device 3. Output of the data interconnect register 6 is connected to the data interconnect input of the instruction fetch gate 3.5; whose fetch permission output is connected to, the fetch permission input of the instruction fetcher 3.1. N instruction fetch permission flag inputs of the instruction fetch gate 3.5 are the sk₁, . . . , skₖ, . . . , sk_{N} inputs of the control device 3. Tag input of the operational device 5 is the tag input of the I/O device 5.1, ALU 5.2 and data memory 5.3. Result tag output and result availability flag output of the I/O device 5.1, ALU 5.2 and data memory 5.3 are, respectively, result tag output MR and result availability flag output SR of the operational device 5. Switchboard 2 consists of N switching nodes 2.1, . . . , 2.K, . . . , 2.N (FIG. 6), each containing N selectors 2.K.1, . . . , 2.K.K, . . . , 2.K.N (FIG. 7); each selector contains a logical number register 12, request flag generator 13, request flag memory 14, and two FIFO buffers 15 and 16. In the k-th selector of all switching nodes (2.1.K, . . . , 2.N.K), k-th data input of the switchboard iₖ is connected to the first data inputs of the FIFO buffers 15 and 16, k-th result tag input mrₖ is connected to the second data inputs of the FIFO buffers 15 and 16 and to the read address input of the request flag memory 14; k-th result availability flag input srₖ is the read gate input of the request flag memory 14. In all selectors of the k-th switching node (2.K.1, . . . , 2.K.N), (2k−1)-th address input of the switchboard a₂ₖ₋₁ is connected to the first operand address inputs of the request flag generators 13; 2k-th address input of the switchboard a₂ₖ is connected to the second operand address inputs of the request flag generators 13; (2k−1)-th operand request flag input s₂ₖ₋₁ is connected to the first operand request flag inputs of the request flag generators 13; 2k-th operand request flag input S₂ₖ is connected to the second operand request flag inputs of the request flag generators 13; k-th logical number input lnₖ is connected to the inputs of the logical number registers 12; k-th operand tag input mₖ is connected to the write address inputs of the request flag memories 14. In all selectors 2.1.1, . . . , 2.N.N, logical number register output 12 is connected to the logical number input of the request flag generator 13; operand present flag output of the request flag generator 13 is connected to write gate input of the request flag memory 14; first and second operand present flag outputs of the request flag generator 13 are respectively connected to the first and second data inputs of the request flag memory 14. First data output of the request flag memory 14 is connected to the write gate input of the first FIFO buffer 15; second data output of the request flag memory 14 is connected to the write gate input of the second FIFO buffer 16. All first FIFO buffers 15 in the k-th switching node 2.K are polled using the read gate in the round-robin discipline, and all first data outputs of the first FIFO buffers are connected together and form the (2k−1)-th data output □₂ₖ₋₁ of the switchboard. All second data outputs of the first FIFO buffers are also connected together and form the (2k−1)-th operand tag output ma₂ₖ₋₁ of the switchboard; operand availability flag outputs of the first FIFO buffers 15 are connected together and form the (2k−1)-th operand availability flag output sa₂ₖ₋₁ of the switchboard. All second FIFO buffers 16 in the k-th switching node 2.K are also polled in the round-robin discipline using the read gate, and first data outputs of the second FIFO buffers are connected together and form the 2k-th data output □₂ₖ of the switchboard. Second data outputs of the second FIFO buffers 16 are connected together and form the 2k-th operand tag output ma₂ₖ of the switchboard; operand availability flag outputs of the second FIFO buffers 16 are connected together and form the 2k-th operand availability flag output sa₂ₖ of the switchboard..

Instruction execution in the asynchronous synergetic computing system involves five consecutive stages.

The first stage comprises instruction word fetching, opcode decoding, setting of flags in the request flag memory (if needed—depends on operation) and generation of the “raw” instruction, including appropriate flags in the operand availability memory and opcode in the opcode buffer.

At the second stage, results of previous operations are received by the switchboard and written to the appropriate FIFO buffers to serve as operands for the current instruction.

At the third stage, operands are read from the FIFO buffers and recorded in the first or second operand buffer.

At the fourth stage, assembled raw instructions are fetched from the opcode buffer and the first and second operand buffers and transmitted for the execution.

The fifth stage is the execution of the operation proper and transmission of the result to the switchboard.

All stages may vary in duration. In every functional unit, up to L instructions may go through different stages of execution. Only the initiation of execution (first stage) is synchronized between units. All other stages occur asynchronously, upon availability of results, operands, and instructions.

Addresses of the first instructions to be executed are set by hardware or software upon loading of the executable code; the initial state of the functional units 1.1, . . . , 1.N (FIG. 5) and the switchboard selectors (FIG. 7) of the asynchronous synergetic computing system is as follows:

busy tag memory 7, request flag memory 14 and FIFO buffers 15 and 16 are cleared;

result availability flags SR, operand availability flags SA₁ and SA₂, and instruction availability flags are cleared (not ready);

data interconnect register 6 is cleared;

instruction fetch permission flag SK is zero (fetch permitted);

logical number register 12, operand availability memory 8, opcode buffer 9, first operand buffer 10 and second operand buffer 11 are in arbitrary state.

Instructions, operands and computation results are identified in the asynchronous synergetic computing system by the instruction fetchers 3.1 using identification tags. Initial value of the tag is zero.

Instruction fetching by the fetcher 3.1 begins from testing of the fetch permission flag from the instruction fetch gate 3.5. If this signal is active (fetching prohibited), the instruction fetcher 3.1 will wait until the signal reverts to zero (fetching permitted), and then will check availability of the next identification tag by reading a word from the busy tag memory 7 at the address equal to the tag value. If this word is cleared, the tag is available, and the instruction fetcher 3.1 sends the instruction address to the program memory 4, writes a non-zero word to the busy tag memory 7 to indicate that the tag is now busy, and sends the tag value via the second tag output to the instruction decoder 3.2. If the word read from the busy tag memory has a non-zero value (tag busy), the instruction fetcher sets fetch permission flag SK to one and waits until the tag becomes available, after which it clears the SK flag and repeats the fetching process from checking the fetch permission flag.

After issuing the instruction address to the program memory 4, marking the tag as busy and issuing the tag value to the instruction decoder 3.2, instruction fetcher generates a new instruction address and tag by incrementing the old values by one (for the tag, incrementing is performed modulo L).

Instruction decoder 3.2 accepts the instruction word from the program memory 4, unpacks it and analyzes the operation code. If the instruction requires one or two operands from the switchboard 2, then the decoder 3.2 generates the tag, one or two operand request flags and one or two operand addresses and transmits them to the switchboard 2 via outputs M, S₁, S₂, A₁ and A₂, respectively. Tag value equals the one received from the instruction fetcher 3.1, address values are taken from the instruction word, and operand request flags are generated as follows: if the instruction uses an operand from the switchboard, the corresponding request flag is set to indicate operand is present; otherwise, it is cleared.. In case of format 2 instructions, where an extra word has to be fetched from the program memory 4 to obtain data, instruction or peripheral address, a signal to this effect is sent to the instruction fetcher 3.1 via its control input. In this case, instruction fetcher fetches an additional instruction word without changing the tag value, and the fetch permission flag (SK) is set active for the duration of the read cycle to suppress instruction fetching in other functional units.

Tag, opcode and data/instruction/peripheral address are transmitted to the instruction assembler 3.3 via the data/control output. Using the tag value as an address, instruction assembler 3.3 clears the corresponding word in the operand availability memory 8, writes the opcode received into the opcode buffer 9, and in case of format 2 instructions also writes the data/instruction/peripheral address to the second operand buffer 11 and raises the second operand availability flag in the operand availability memory 8. Operands arriving from other functional units are recorded in the buffers upon detection of active operand availability flags SA₁, and SA₂ (operand is ready). Tag values received via the MA₁ and MA₂ inputs are used as addresses in the first operand buffer 10 and second operand buffer 11 to write operand values I₁ and I₂, respectively. As the system is asynchronous, operand values do not necessarily arrive simultaneously. Concurrently with recording of the operand values in operand buffers, corresponding flags are set in the operand availability memory 8: a word is read from the operand availability memory and bits corresponding to the arriving operands are set to one; then availability of both operands is checked. The modified word is written back to the operand availability memory 8; if both operands were found to be ready, an instruction ready flag is generated at the instruction ready flag output, and tag value for the last operand received—at the fifth tag output; they are sent to the instruction execution controller 3.4. The latter reads the opcode from the opcode buffer 9, first operand value from the first operand buffer 10, and second operand value from the second operand buffer 11, using the tag value received as an address. The tag is marked available by clearing the word at the same address in the busy tag memory, and the opcode is analyzed. If the instruction does not use data memory 5.3, ALU 5.2 or I/O device 5.1—that is, if it does not generate a result for the switchboard 2, then the instruction is executed directly by the instruction execution controller 3.4 (branch instructions, instructions setting logical number, loading the program memory 4, setting the data interconnect register 6, etc.). Otherwise, the instruction execution controller 3.4 generates a new tag value by incrementing the old one by one (modulo L) and transmits the new tag value, opcode and both operand values to the operational device 5 via the fifth tag output, control output, and first and second data outputs, respectively.

Operational device 5 executes the instruction and generates the result availability flag SR, result tag (at the result tag output MR) and the result itself (at the data output O).

If instructions do not compete for devices, they may be executed concurrently, for example: data memory access and execution of an operation by the ALU, or addition operation and multiplication operation if the adder and the multiplier in the ALU can operate concurrently and independently. If the results are generated simultaneously, they are sent to the switchboard 2 in the order of instruction fetching.

Data interconnect register 6 is N bits wide and determines which functional units must fetch instructions synchronously. Data-related functional units are marked with ones (k-th functional unit corresponds to the k-th bit of the register). The value in the data interconnect register 6 is used to generate the fetch permission flag sent by the instruction fetch gate 3.5 to the instruction fetcher 3.1. If the i-th bit of the data interconnect register 6 is set and skᵢ, is also set, then the instruction fetch permission flag is active (fetching is prohibited).

The switchboard is involved in the second and third stages of instruction execution.

For the second stage, request bits are set in the request flag memory 14: request flag generator 13 analyzes the operand request flags s₂ₖ₋₁ and s₂ₖ. If s₂ₖ₋₁ is set, then the value on the logical number register 12 is compared to the first operand address a₂ₖ₋₁. If they match, first operand request bit is set (operand present), otherwise it is cleared (operand absent). Second operand request bit is generated in a similar manner. The two-bit word is written to the request flag memory 14 at the address equal to the tag value received via the operand tag input mₖ.

A result received by the switchboard 2 via the data input iₖ is accompanied by the result availability flag srₖ and the result tag mrₖ. Upon receipt of an active result availability flag, in all selectors connected to the given data input (2.1.K, 2.2.K, . . . , 2.N.K) a word from the request flag memory 14 at the address equal to the tag received is read and then cleared. First bit of this word is used as the write gate signal for the first FIFO buffer 15, second bit—for the second FIFO buffer 16. If the corresponding bit is raised, then the result from the data input iₖ and the tag from the tag input mrₖ are latched in the corresponding FIFO buffer.

Concurrently with writing to the FIFO buffers 15 and 16, they are polled for previously recorded information, which is transmitted to the instruction assembler. Polling occurs in the round-robin discipline, separately for all first FIFO buffers 15 of the switching node 2.K and all second FIFO buffers of this node. Data are consecutively read from the first FIFO buffer of the selector 2.K.N, then 2.K.N−1 and so on to 2.K.1, and from 2.K.N again; same for the second FIFO buffer.

If a given first FIFO buffer is empty, the next one is polled; otherwise, an operand availability flag sa₂ₖ₋₁ is generated and result and tag are output to the data output □₂ₖ₋₁ and the operand tag output ma₂ₖ₋₁, respectively. Data are fetched and transmitted repeatedly until the current FIFO buffer is exhausted, then the next buffer is polled, etc.

Consider the operation of the asynchronous synergetic computing system with formulae F.1 and F.2.

Assume the asynchronous synergetic computing system to have 16 functional units, units 1 to 15 containing data memory and ALU, and unit 16 being an I/O unit. Instruction sets, instruction timing, mnemonics and tabular notation used are the same as in the previous example.

Matrix elements (a₁₁, a,₁₂, a₁₃, a₂₁, a₂₂, a₂₃, a₃₁, a₃₂, a₃₃) are placed one element per unit in the data memory of the units 1-9. Vectors (b₁, b₂, b₃) and (c₁, c₂, c₃) are placed one element per unit in the units 10-12. Variables e, d, x are placed in the units 10, 11, 12, respectively, y and v—in unit 13, z and w—in unit 14.

Intermediate results will be stored in a location r₁ in unit 14.

Execution of the code calculating formulae (F.1) and (F.2) is presented in Table 2.

The bottom row of the table shows the number of instructions executed by each of the functional units.

When writing code for the asynchronous synergetic computing system, all instructions are assumed to take one cycle. Their real duration is accounted for at runtime. Table 3 presents the actual instruction timing as the system executes the code.

### Industrial Applicability

The invention may be used when designing high-performance parallel computing systems for various purposes, such as computation-intensive scientific problems, multimedia and digital signal processing. The invention may also be used for high-speed switching equipment in telecommunication systems.

TABLE 2

| Instruc- | | | | | | | | | | | | | | | | |
|---|---|---|---|---|---|---|---|---|---|---|---|---|---|---|---|---|
| tion | Functional unit number | | | | | | | | | | | | | | | |
| no. | 1 | 2 | 3 | 4 | 5 | 6 | 7 | 8 | 9 | 10 | 11 | 12 | 13 | 14 | 15 | 16 |
| 1 | rd | rd | rd | rd | rd | rd | rd | rd | rd | rd | rd | rd | d | d | | |
| | □₁₁ | □₁₂ | □₁₃ | □₂₁ | □₂₂ | □₂₃ | □₃₁ | □₃₂ | □₃₃ | b₁ | b₂ | b₃ | 1 | 1 | | |
| 2 | * | * | * | * | * | * | * | * | * | rd | rd | Rd | rd | d | | |
| | 1,10 | 2, 11 | 3, 12 | 4, 10 | 5, 11 | 6, 12 | 7, 10 | 8, 11 | 9, 12 | e | d | X | y | 1 | | |
| 3 | + | | d | + | | d | + | | d | − | + | D | rd | d | | |
| | 1, 2 | | 1 | 4, 5 | | 1 | 7, 8 | | 1 | 10, 11 | 12, 13 | 1 | v | 1 | | |
| 4 | + | | | + | | | + | | d | * | / | − | rd | rd | | |
| | 1, 3 | | | 4, 6 | | | 7, 9 | | 1 | 10, 12 | 10, 11 | 11, 13 | y | z | | |
| 5 | | | | | | | | | − | wr | wr | wr | * | wr | | |
| | | | | | | | | | 10, 13 | 1,c₁ | 4, c₂ | 7, c₃ | 11, 14 | 12, r₁ | | |
| 6 | | | | | | | | | d | | | | − | d | | |
| | | | | | | | | | 1 | | | | 13, 14 | 1 | | |
| 7 | | | | | | | | | * | | | | | d | | |
| | | | | | | | | | 9, 13 | | | | | 1 | | |
| 8 | | | | | | | | | | | | | | wr | wr | |
| | | | | | | | | | | | | | | 9, w | | |
| | 4 | 2 | 3 | 4 | 2 | 3 | 4 | 2 | 7 | 5 | 5 | 5 | 6 | 8 | − | − |

Number of instructions executed

TABLE 3

| | Functional unit number | | | | | | | | | | | | | | | |
|---|---|---|---|---|---|---|---|---|---|---|---|---|---|---|---|---|
| Cycle | 1 | 2 | 3 | 4 | 5 | 6 | 7 | 8 | 9 | 10 | 11 | 12 | 13 | 14 | 15 | 16 |
| 1 | rd | rd | rd | rd | rd | rd | rd | rd | rd | rd | rd | rd | d | d | | |
| | □₁₁ | □₁₂ | □₁₃ | □₂₁ | □₂₂ | □₂₃ | □₃₁ | □₃₂ | □₃₃ | b₁ | b₂ | b₃ | 1 | 1 | | |
| 2 | * | * | * | * | * | * | * | * | * | rd | rd | rd | rd | d | | |
| | 1, 10 | 2, 11 | 3, 12 | 4, 10 | 5, 11 | 6, 12 | 7, 10 | 8, 11 | 9, 12 | e | d | x | y | 1 | | |
| 3 | | | | | | | | | | − | + | d | rd | d | | |
| | | | | | | | | | | 10, 11 | 12, 13 | 1 | v | 1 | | |
| 4 | + | | d | + | | d | + | | d | * | / | − | rd | rd | | |
| | 1, 2 | | 1 | 4, 5 | | 1 | 7, 8 | | 1 | 10, 12 | 10, 11 | 11, 13 | y | z | | |
| 5 | + | | | + | | | + | | d | | | | | wr | | |
| | 1, 3 | | | 4, 6 | | | 1, 9 | | 1 | | | | | 12, r₁ | | |
| 6 | | | | | | | | | − | wr | wr | wr | | d | | |
| | | | | | | | | | 10, 13 | 1, c₁ | 4, c₂ | 7, c₃ | | 1 | | |
| 7 | | | | | | | | | d | | | | | d | | |
| | | | | | | | | | 1 | | | | | 1 | | |
| 8 | | | | | | | | | | | | | * | | | |
| | | | | | | | | | | | | | 11, 14 | | | |
| 9 | | | | | | | | | | | | | | | | |
| 10 | | | | | | | | | | | | | − | | | |
| | | | | | | | | | | | | | 13, 14 | | | |
| 11 | | | | | | | | | * | | | | | | | |
| | | | | | | | | | 9, 13 | | | | | | | |
| 12 | | | | | | | | | | | | | | | | |
| 13 | | | | | | | | | | | | | | wr | | |
| | | | | | | | | | | | | | | 9, w | | |
| 14 | | | | | | | | | | | | | | | | |
| | 5 | 3 | 4 | 5 | 3 | 4 | 5 | 3 | 12 | 6 | 7 | 6 | 10 | 13 | − | − |

Operating time of the functional units

□—idle time of a functional unit waiting for operands;

|□|—an instruction executed simultaneously with another, longer instruction.

1. Synergetic computing system containing N functional units 1.1, . . . , 1.N and an each-to-each switchboard (2) with N data inputs i₁, . . . , iₖ, . . . , i_{N}, 2N address inputs a₁, a₂, . . . , a₂ₖ₋₁, a₂ₖ, . . . , a_{2N-1}, a_{2N} and 2N data outputs o₁, o₂, . . ., o₂ₖ₋₁, o₂ₖ, . . . , o_{2N-1}, o_{2N} (see FIG. 1), characterized that every functional unit 1.1, . . . , 1.N consists of a control device (3), program memory (4) and an operational device (5) implementing binary and unary operations, and has two data inputs I₁, I₂, two address outputs A₁, A₂ and one data output o, where first data input I₁ of the k-th functional unit, k=1, . . . , N is connected to the 2k−1-th data output of the switchboard o₂ₖ₋₁; second data input is connected to the 2k-th data output of the switchboard (o₂ₖ); first address output (A₁) is connected to the 2K−1-th address input of the switchboard a₂ₖ₋₁; second address output A₂ is connected to the 2k-th address input of the switchboard a₂ₖ; data output o of the k-th functional unit is connected to the k-th data input of the switchboard iₖ; data inputs I₁, I₂ of the functional unit (1.K) are the data inputs of the control device (3); address outputs of the functional unit A₁, A₂ are, respectively, first and second address outputs of the control device (3); third address output of the control device (3) is connected to the address input of the program memory (4); instruction input/output of the control device (3) is connected to the instruction input/output of the program memory (4); control output of the control device (3) is connected to the control input of the operational device (5); first and second data outputs of the control device (3) are connected, respectively, to the first and second data inputs of the operational device (5); data output of the operational device (5) is the data output of the functional unit (1.K); the operational device (5) contains an input/output device (5.1) and/or an arithmetic and logic unit (5.2) and/or data memory (5.3), where first data input of the operational device (5) is the data input of the I/O device (5.1), the ALU (5.2) and the data memory (5.3); second data input of the operational device (5) is the address input of the I/O device (5.1) and the data memory (5.3) and the second data input of the ALU (5.2); control input of the operational device (5) is the control input of the I/O device (5.1), the ALU (5.2) and the data memory (5.3); data output of the I/O device (5.1), the ALU (5.2) and the data memory (5.3) is the data output of the operational device (5).

2. Device as described in claim 1, characterized that every functional unit 1.1, . . . , 1.K, . . . , 1.N has two operand tag inputs MA₁, MA₂, two operand availability flag inputs SA₁, SA₂, an operand tag output M, two operand request flag outputs S₁, S₂, a result tag output MR, a result availability flag output SR, a logical number output LN, N instruction fetch permission flag inputs sk₁, . . . , skₖ, . . . , sk_{N}, an instruction fetch permission flag output SK, and the switchboard (2) has N result tag inputs mr₁, . . . , mrₖ, . . . , mr_{N}, N result availability flag inputs sr₁, . . . , srₖ, . . . , sr_{N}, N operand tag inputs m₁, . . . , mₖ, . . . . , m_{N}, 2N operand request flag inputs s₁, s₂, . . . , s₂ₖ₋₁, s₂ₖ, . . . , s_{2N-1}, s_{2N}, N logical number inputs 1n₁, . . . , 1nₖ, . . . , 1n_{N}, 2N operand tag outputs ma₁, ma₂, . . . , ma₂ₖ₋₁, ma₂ₖ, . . . , ma_{2N-1}, ma_{2N}, 2N operand availability flag outputs sa₁, sa₂, . . . , sa₂ₖ₋₁, sa₂ₖ, . . . , sa_{2N-1}, sa_{2N}, where for the k-th functional unit, k=1, . . . , N, first and second operand tag inputs MA₁, MA₂ are respectively connected to 2k−1-th and 2k-th operand tag outputs of the switchboard ma₂ₖ₋₁, ma₂ₖ; first and second operand availability flag inputs SA₁, SA₂ are respectively connected to 2k−1-th and 2k-th operand availability flag outputs of the switchboard sa₂ₖ₋₁, sa₂ₖ; operand tag outputs M is connected to the k-th operand tag input of the switchboard mₖ; first and second operand request flag outputs S₁, S₂ are respectively connected to 2k−1-th and 2k-th operand request flag inputs of the switchboard s₂ₖ₋₁, s₂ₖ; result tag output MR is connected to the k-th result tag input of the switchboard mrₖ; result availability flag output SR is connected to the k-th result availability flag input of the switchboard srₖ; instruction fetch permission flag output SK is connected to the k-th instruction fetch permission flag input skₖ of all functional units 1.1, . . . , 1.K, . . . , 1.N. Additionally, operand tag inputs MA₁, MA₂ and operand availability flag inputs SA₁, SA₂ of the functional unit 1.K are corresponding inputs of the control device (3); operand tag output M and operand request flag outputs S₁, S₂ of tile functional unit 1.K are respective outputs of the control device (3); tag output of the control device (3) is connected to the tag input of the operational device (5); result tag output MR and result availability flag output SR of the operational device (5) are respective outputs of the functional unit 1.K; logical number output LN, N instruction fetch permission flag inputs sk₁, . . . , skₖ, . . . , sk_{N} and instruction fetch permission flag output SK of the functional unit 1.K are respective outputs and inputs of the control device (3); the control device (3) consists of instruction fetcher (3.1), instruction decoder (3.2), instruction assembler (3.3), instruction execution controller (3.4), instruction fetch gate (3.5), N-bit-wide data interconnect register (6), busy tag memory (7), operand availability memory (8), opcode buffer (9), first operand buffer (10), second operand buffer (11), the latter five entities being L words in size; the address output of the instruction fetcher (3.1) is the third address output of the control device (3); instruction output of the instruction fetcher (3.1) is the instruction output of the control device (3); first tag output of the instruction fetcher (3.1) is connected to the read address input of the busy tag memory (7); tag busy flag input of the instruction fetcher (3.1) is connected to the data output of the busy tag memory (7); second tag output of the instruction fetcher (3.1) is connected to the tag input of the instruction decoder (3.2) and the write address input of the busy tag memory (7); tag busy flag output of the instruction fetcher (3.1) is connected to the data input of the busy tag memory (7); control input of the instruction fetcher (3.1) is connected to the control output of the instruction decoder (3.2); data input of the instruction fetcher (3.1) is connected to the third data output of the instruction execution controller (3.4); instruction fetch permission flag output SK of the instruction fetcher (3.1) is the corresponding output of the control device (3); instruction input of the instruction decoder (3.2) is the instruction input of the control device (3); operand tag output M, operand request flag outputs S₁, S₂, and address outputs A₁, A₂ of the instruction decoder (3.2) are respective outputs of the control device (3); data/control output of the instruction decoder (3.2) is connected to the data/control input of the instruction assembler (3.3); operand tag inputs MA₁, MA₂, operand availability flag inputs SA₁, SA₂ and data inputs I₁, I₂ of the instruction assembler (3.3) are corresponding inputs of the control device (3); first tag output of the instruction assembler (3.3) is connected to the address input of the operand availability memory (8); second, third and fourth tag outputs of the instruction assembler (3.3) are respectively connected to the write address inputs opcode buffer (9), first operand buffer (10) and second operand buffer (11); first data input/output of the instruction assembler (3.3) is connected to the data input/output of the operand availability memory (8); second, third and fourth data outputs of the instruction assembler are respectively connected to data inputs of the opcode buffer (9), first operand buffer (10) and second operand buffer (11); instruction ready flag output of the instruction assembler (3.3) is connected to the instruction ready flag input of the instruction execution controller (3.4); fifth tag output of the instruction assemble, (3.3) is connected to the tag input of the instruction execution controller (3.4); first, second and third tag outputs of the instruction execution controller (3.4) are respectively connected to the read address inputs of the opcode buffer (9), first operand buffer (10) and second operand buffer (11); first, second and third data inputs of the instruction execution controller (3.4) are respectively connected to the data outputs of the opcode buffer (9), first operand buffer (10) and second operand buffer (11); logical number output LN of the instruction execution controller (3.4) is an output of the control device (3); fourth tag output of the instruction execution controller (3.4) is connected to the write address input of the busy tag memory (7); tag busy flag output of the instruction execution controller (3.4) is connected to the data input of the busy tag memory (7); data interconnect output of the instruction execution controller (3.4) is connected to the input of the data interconnect register (6); fifth tag output of the instruction execution controller (3.4) is the tag output of the control device (3); control output, first and second data outputs of the instruction execution controller (3.4) are respective outputs of the control device (3); output of the data interconnect register (6) is connected to the data interconnect input of the instruction fetch gate (3.5); instruction fetch permission output of the instruction fetch gate (3.5) is connected to the instruction fetch permission input of the instruction fetcher (3.1); N instruction fetch permission flag inputs sk₁, . . . , skₖ, . . . , sk_{N} of the instruction fetch gate (3.5) are corresponding inputs of the control device (3); tag input of the operational device (5) is the tag input of the I/O device (5.1), the ALU (5.2) and the data memory (5.3); result tag output and result availability flag output of the I/O device (5.1), the ALU (5.2) and the data memory (5.3) are, respectively, result tag output MR and result availability flag output SR of the operational device (5); the switchboard (2) consists of N switching nodes 2.1, . . . , 2.K, . . . , 2.N, each containing N selectors 2.K.1, . . . , 2.K.K, . . . , 2.K.N, each selector containing a log₂N-bit logical number register (12), a request flag generator (13), L-word request flag memory (14), two FIFO buffers (15, 16), where for the k-th selector, k=1, . . . , N in all switching node, k-th data input of the switchboard iₖ is connected to first data inputs of the FIFO buffers (15, 16); k-th result tag input mrₖ is connected to the second data inputs of the FIFO buffers (15, 16) and to the read address input of the request flag memory (14); k-th result availability flag input srₖ is connected to the read gate input of the request flag memory (14); for all selectors of the k-th switching node 2.K.1, . . . , 2.K.K, . . . , 2.K.N, 2k−1-th address input of the switchboard a₂ₖ₋₁ is connected to the first operand address inputs of the request flag generators (13); 2k-th address input of the switchboard a₂ₖ is connected to the second operand address inputs of the request flag generators (13); 2k−1-th operand request flag input s₂ₖ₋₁ is connected to the first operand request flag inputs of the request flag generators (13); 2k-th operand request flag input s₂ₖ is connected to the second operand request flag inputs of the request flag generators (13); k-th logical number input 1nₖ is connected to the inputs of the logical number registers (12); k-th operand tag input mrₖ is connected to the write address inputs of the request flag memories (14); in all selectors 2.K.1, . . . , 2.K.K, . . . , 2.K.N, logical number register output (12) is connected to the logical number input of the request flag generator (13); operand present flag output of the request flag generator (13) is connected to the write gate input of the request flag memory (14); first and second operand present flag outputs of the request flag generators (13) are respectively connected to the first and second data inputs of the request flag memory (14); first data output of the request flag memory (14) is connected to the write gate input of the first FIFO buffer (15); second data output of the request flag memory (14) is connected to write gate input of the second FIFO buffer (16); all first FIFO buffers (15) of the k-th switching node are cyclically polled via the read gate in a round-robin discipline; first data outputs of the first FIFO buffers (15) are connected together and form the 2k−1-th data output of the switchboard o₂ₖ₋₁; second data outputs of the first FIFO buffers (15) are connected together and form the 2k−1-th operand tag output of the switchboard ma₂ₖ₋₁; operand availability flag outputs of the first FIFO buffers (15) are connected together and form the 2k−1-th operand availability flag output of the switchboard sa₂ₖ₋₁; all second FIFO buffers (16) of the k-th switching node are also cyclically polled via the read gate in a round-robin discipline; first data outputs of the second FIFO buffers (16) are connected together and form the 2k-th data output of the switchboard o₂ₖ, second data outputs of the second FIFO buffers (16) are connected together and form the 2k-th operand tag output of the switchboard ma₂ₖ; operand availability flag outputs of the second FIFO buffers (16) are connected together and form the 2k-th operand availability flag output of the switchboard sa₂ₖ.
